(19) United States
(12) Patent Application Publication
(10) Pub. No.: US 2010/0151315 A1
(43) Pub. Date: Jun. 17, 2010

(54) PRISMATIC ACCUMULATOR

(75) Inventor: Rolf Wiepen, Schwerte (DE)

Correspondence Address: FOLEY & LARDNER LLP, 777 EAST WISCONSIN AVENUE, MILWAUKEE, WI, 53202-5306, US

(73) Assignee: Johnson Controls Hybrid and Recycling GmbH

(21) Appl. No.: 12/642,494

(22) Filed: Dec. 18, 2009

Related U.S. Application Data
(63) Continuation of application No. PCT/DE2008/000977, filed on Jun. 13, 2008.

(30) Foreign Application Priority Data
Jul. 2, 2007 (DE) 10 2007 030 652.2

(51) Int. Cl. H01M 2/24; H01M 2/00

(52) U.S. Cl. 429/160; 29/623.1

(57) ABSTRACT

A prismatic accumulator includes a first cell vessel having a first-cell plate stack disposed therein and at least one second cell vessel having a second-cell plate stack disposed therein and separated from the first cell vessel by an electrically insulating intermediate wall. At least one first-cell contact connector metal sheet is provided in the first cell vessel and is connected to the intermediate wall and is in contact with the first-cell plate stack. At least one second-cell contact connector metal sheet is provided in the second cell vessel and is in contact with the second-cell plate stack. Each of the contact connector metal sheets is in contact with the associated plate stack via at least one spring tongue, wherein the at least one spring tongue exerts a mechanical pressure on the associated plate stack with a free end that is in contact with the respective plate stack.

### CROSS-REFERENCE TO RELATED PATENT APPLICATIONS

The present application is a Continuation of International Application No. PCT/DE2008/000977, filed Jun. 13, 2008, which claims the benefit of and priority to German Priority Patent Application No. 10 2007 030 652.2, filed Jul. 2, 2007. The entire disclosures of International Application No. PCT/DE2008/000977 and German Priority Patent Application No. 10 2007 030 652.2 are incorporated herein by reference.

### BACKGROUND

The invention relates to a prismatic accumulator and a method for producing a prismatic accumulator.

A prismatic accumulator of this type is known from DE 10 2004 003 066 A1, for example. What is disadvantageous about the prismatic accumulator described therein is the complex manufacture thereof. This is because the plate stacks have to be mounted in the context of serial mounting. In the course of this serial mounting, the plate stacks of the individual cell vessels are progressively introduced into the corresponding cell vessels and welded to one another. This results in a long manufacturing duration.

DE 26 19 865 discloses a generic prismatic accumulator in which the plate stacks are connected to conductor metal sheets on the cell walls via an expanded metal piece serving as a resilient conductor inlay. What is disadvantageous about this is that damage can easily occur during the insertion of the plate stacks on account of the high forces required which leads to rejects.

It would be advantageous to provide a prismatic accumulator and a method for producing a prismatic accumulator, the production of which incurs only few rejects and in which the plate stacks are nevertheless securely fixed.

### SUMMARY

An exemplary embodiment relates to a prismatic accumulator that includes a first cell vessel having a first-cell plate stack disposed therein and at least one second cell vessel having a second-cell plate stack disposed therein and separated from the first cell vessel by an electrically insulating intermediate wall. At least one first-cell contact connector metal sheet provided in the first cell vessel that is connected to the intermediate wall is in contact with the first-cell plate stack. At least one second-cell contact connector metal sheet provided in the second cell vessel is in contact with the second-cell plate stack. Each of the contact connector metal sheets is in contact with the associated plate stack via at least one spring tongue, wherein the at least one spring tongue exerts a mechanical pressure on the associated plate stack with a free end that is in contact with the respective plate stack and is arranged such that it presents a higher mechanical resistance to a movement of the plate stack out of the associated cell vessel than to a movement into the associated cell vessel.

Another exemplary embodiment relates to a method for producing a prismatic accumulator that includes providing a housing having a first cell vessel and at least one second cell vessel which are separated from the first cell vessel by an electrically insulating intermediate wall. The method also includes introducing at least one first-cell contact connector metal sheet into the first cell vessel and introducing at least one second-cell contact connector metal sheet into the second cell vessel. The method further includes connecting the at least one first-cell contact connector metal sheet to the at least one second-cell contact connector metal sheet, introducing at least one first-cell plate set into the first cell vessel such that it is brought into permanent contact with the at least one first-cell contact connector metal sheet, and introducing at least one second-cell plate stack into the second cell vessel such that it is brought into contact with the at least one second-cell contact connector metal sheet. Each of the contact connector metal sheets has at least one spring tongue and is introduced in such a way that the at least one spring tongue exerts a mechanical pressure on the associated plate stack with a free end that is in contact with the plate stack, and is arranged in such a way that it presents a higher mechanical resistance to a movement of the plate stack out of the cell vessel than to a movement into the cell vessel.

### BRIEF DESCRIPTION OF THE DRAWINGS

An exemplary embodiment of the invention is explained in greater detail below. In this case:

FIG. 1a shows a cross-sectional view of a prismatic accumulator according to the invention, the plate stacks not yet having been introduced into the cell vessels,

FIG. 1b shows an excerpt from FIG. 1a with two contact connector metal sheets,

FIG. 1c shows a perspective view of a plate stack for an accumulator according to the invention,

FIG. 2a shows a view in direction A from FIG. 1a,

FIG. 2b shows a contact connector metal sheet with a plurality of spring tongues, perforated (without rivet), in prefabrication,

FIG. 3a shows a schematic view of how a contact connector metal sheet is connected to a rivet,

FIG. 3b shows a schematic view of how a first-cell contact connector metal sheet is connected to a second-cell contact connector metal sheet,

FIG. 4 shows a schematic view of how a marginal contact connector metal sheet is connected to a pole connector element,

FIG. 5 shows a cross-sectional view through a prismatic accumulator according to the invention.

### DETAILED DESCRIPTION

The invention relates to a prismatic accumulator comprising a first cell vessel, a first-cell plate stack accommodated in the first cell vessel, at least one second cell vessel, one second-cell, plate stack accommodated in the second cell vessel, wherein the first cell vessel and the second vessel are separated by an electrically insulating intermediate wall, comprising at least one first-cell contact connector metal sheet which is arranged in the first cell vessel, is connected to the intermediate wall and is in contact with the first-cell plate stack, and comprising at least one second-cell contact connector metal sheet which is arranged in the second cell vessel and is in contact with the second-cell plate stack. In this case, first-cell contact connector metal sheet and second-cell contact connector metal sheet are electrically conductively connected to one another.

In accordance with a second aspect, the invention relates to a method for producing a prismatic accumulator comprising the following steps: (a) providing a housing having a first cell vessel and at least one second cell vessel which are separated from the first cell vessel by an electrically insulating intermediate wall, (b) introducing at least one first-cell contact connector metal sheet into the first cell vessel, (c) introducing at least one second-cell contact connector metal sheet into the second cell vessel, (d) connecting the at least one first-cell contact connector metal sheet to the at least one second-cell contact connector metal sheet, and (e) introducing respectively at least one first-cell plate set into the first cell vessel, such that it is brought into permanent contact with the at least one first-cell contact connector metal sheet, and (f) introducing respectively at least one second-cell plate stack into the second cell vessel such that it is brought into contact with the at least one second-cell contact connector metal sheet.

One advantage of an exemplary embodiment of the present application is that contact connector metal sheets associated with different cell vessels can be mounted simultaneously. Therefore, if the prismatic accumulator comprises more than two cell vessels, in particular a multiplicity of cell vessels, the contact connector metal sheets of adjacent cell vessels can be fixed on the respective intermediate walls in a parallel process. It is possible, therefore to mount all the contact connector metal sheets using only one machine in only one work step, which significantly minimizes the manufacturing time.

A further advantage is that the side walls of the vessel do not have to be opened in order to produce connections between the electrode stacks.

A further advantage is that the plate stacks can be mounted more simply and more rapidly. This is because it suffices simply to insert the plate stacks into the cell vessels prepared with the contact connector metal sheets. The spring tongues then exert a mechanical pressure on the plate stack, such that an electrical contact arises between the plate stack and the spring tongues. Joining methods can thus be dispensed with. A further advantage is that individual plate sets can be exchanged in a simple manner as required.

In the context of the present description, a plate stack is understood to mean, in particular an arrangement of connected pole plates which serve as electrodes of the accumulator. The mechanical pressure exerted on the plate stack by the spring tongues is dimensioned for example such that, on the one hand, it does not damage the plate stacks and, on the other hand, it ensures an electrical contact even when the prismatic accumulator is subjected to vibration.

The material of the contact connector metal sheets—spring tongue is preferably spring steel.

In one preferred embodiment, the second-cell contact connector metal sheet is connected to the intermediate wall in a manner lying opposite the first-cell contact connector metal sheet with respect to the intermediate wall. It is possible, but not necessary, for the first-cell contact connector metal sheet to be constructed mirror-symmetrically relative to the second-cell contact connector metal sheet with respect to the intermediate wall. It suffices, however, for the second-cell contact connector metal sheet to be arranged relative to the first-cell contact connector metal sheet such that both can be mechanically and electrically connected by means of a rivet running perpendicular to the intermediate wall.

Preferably, the plate stacks each comprise at least one output conductor metal sheet and the spring tongues are arranged in such a way that they exert the mechanical pressure on the at least one output conductor metal sheet. Output conductor metal sheets are used to mechanically and elastically connect and thus combine a plurality of pole plates in the plate stack. The output conductor metal sheet is for example arranged on a narrow side of the plate stack and mechanically and electrically connected to the pole plates.

In order to securely hold the plate stacks in the respective cell vessel and make electrical contact with them in conjunction with a low internal resistance of the accumulator, each plate stack is preferably in contact with at least three spring tongues on both sides.

It is particularly expedient if the first-cell contact connector metal sheet and the second-cell contact connector metal sheet are mechanically and electrically connected by a rivet. It has been found that a permanent, robust and at the same time simply constructed connection between the contact connector metal sheets is thus possible.

If the prismatic accumulator is filled with accumulator liquid, it is necessary to prevent an exchange of said accumulator liquid between the individual cell vessels and thus between the individual galvanic elements of the accumulator, in order to prevent creepage currents that would otherwise lead to a self-discharge. It has been found that this can be achieved by virtue of the fact that the rivet arranged in a rivet hole in the intermediate wall forms a press fit with the rivet hole. Sealing edges running around the rivet hole can additionally be provided on the cell vessel. Since the accumulator liquid is often an alkaline solution, that is to say that it has a pH value above 7, the rivet is preferably arranged in the rivet hole tightly with respect to alkaline solution. Since the rivet closes off the rivet hole tightly with respect to alkaline solution, additional sealing elements can be dispensed with. It is additionally possible to brace the rivet against the contact connector metal sheet or contact connector metal sheets which it connects to one another in such a way that the contact connector metal sheets bear on the walls of the respective cell vessels tightly with respect to alkaline solution. An axial pre-stress is thus generated which is applied in the axial direction of the rivets. The sealing can additionally be effected axially through the contact connector metal sheet and radially by way of the diameter of the rivet.

Preferably, the prismatic accumulator has exactly two contact connector metal sheets, which are arranged on both sides of the respective plate stack. As an alternative, however, the accumulator can also have a multiplicity of first-cell contact connector metal sheets and second-cell contact connector metal sheets per cell vessel. By way of example, three, four, five or more contact connector metal sheets are possible, it being expedient to provide as many second-cell contact connector metal sheets as there are first-cell contact connector metal sheets.

According to the invention, the spring tongues each have at least one free end and are in contact with the respective plate stack by said free end, wherein the spring tongues are arranged with their free ends such that they present a higher mechanical resistance to a movement of the plate stack out of the cell vessel than to a movement into the cell vessel. What is achieved in this way is that the plate stacks can be inserted into the cell vessels in a simple manner, and in the process they experience only a small force from the spring tongues during insertion. After insertion, the plate stacks are then held in place by the spring tongues which act like barbs. Once the plate stacks have been introduced into the cell vessel, the spring tongues thus exert a clamping force on the plate stack.

Preferably, the spring tongues are formed integrally on the contact connector metal sheets. By way of example, the contact connector metal sheets are produced by being stamped out from a spring steel strip and the spring tongues are subsequently bent out. In this case, the connecting webs should be narrow-flexible.

The invention is particularly suitable for a nickel-metal hydride accumulator. In one preferred embodiment, a nickel-metal hydride accumulator of this type comprises a multiplicity of cell vessels, for example more than five, which are respectively interconnected in pairs as described for the first and second cell vessels in claim 1. The invention can also be used for nickel-cadmium accumulators.

In order to achieve an increased voltage of the accumulator, a positive and a negative first-cell and second-cell plate stack are in each case accommodated in the first and in the second cell vessel and plate stacks of unlike polarity are connected to one another by the contact connector metal sheets. The more cell vessels there are in the accumulator the greater the advantage of the invention since all the contact connector metal sheets of all the intermediate walls between the individual cell vessels can be simultaneously connected to one another using a suitable tool.

In the context of a method according to the invention, the riveting is preferably cold riveting. A cold riveting process can be carried out in a particularly simple manner and leads to a sealing-element-free riveted connection—which is tight with respect to alkaline solution—between the contact connector metal sheets of different cell vessels. The fact that the riveted connection is embodied in sealing-element-free or seal-free fashion should be understood to mean, in particular, that no sealing elements are arranged in direct proximity to the rivet hole. The rivet ensures tightness with respect to alkaline solution as a result of its press fit with the rivet hole and also as a result of axial pre-stressing of the contact connector metal sheets with respect to the housing intermediate wall.

Particularly advantageously, a multiplicity of contact tongues and rivet bushings are provided. The internal resistance is thereby kept small with short current paths.

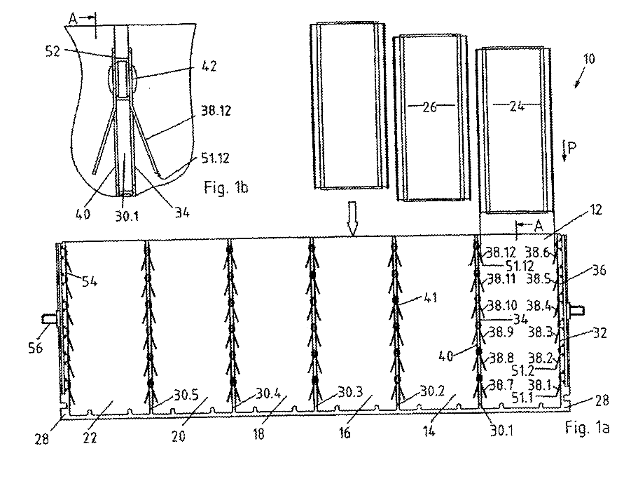

FIG. 1a shows a prismatic accumulator 10 comprising a first cell vessel 12, a second cell vessel 14 and also a third, fourth, fifth and sixth cell vessel 16, 18, 20 and 22, respectively. A first-cell plate stack 24 is accommodated in the first cell vessel (12), but is depicted in an extension of the first cell vessel 12 in FIG. 1a. A second-cell plate stack 26 is accommodated in the second cell vessel (14) in the same way.

The cell vessels 12 to 22 are formed in a basic body 28 composed of plastic. The basic body 28 has intermediate walls 30.1, 20.2 . . . 30.5, which separate the cell vessels 12 to 22 from one another in an electrically insulating manner. Arranged in the first cell vessel 12 are a first first-cell contact connector metal sheet 32 and a second first-cell contact connector metal sheet 34, which are fixed to an outer wall 36 and the intermediate wall 30.1, respectively. Spring tongues 38.1 to 38.12 project from the first-cell contact connector metal sheets 32, 34 into an interior of the first cell vessel 12. In the same way, a first second-cell contact connector metal sheet is arranged on the intermediate wall 30.1 in such a way that spring tongues, with respect to the intermediate wall 30.1, are arranged symmetrically relative to the spring tongues 38.7 to 38.12 of the second first-cell contact connector metal sheet 34. Fixed to the intermediate wall 30.2 is a second second-cell contact connector metal sheet 41, the spring tongues of which, like those of the first second-cell contact connector metal sheet 40, project into an interior of the second cell vessel 14.

FIG. 1b shows an excerpt from FIG. 1a with the spring tongue 38.12 and the associated spring tongue of the first second-cell contact connector metal sheet 40. It can be discerned that the second first-cell contact connector metal sheet 34 is connected to the first second-cell contact connector metal sheet 40 by means of a rivet 42.

The plate stacks, such as the first-cell plate stack 24 and the second-cell plate stack 26, comprise as shown in FIG. 1c, in each case a positive plate stack 44 composed of positive pole plates and a negative plate stack 46 composed of negative pole plates arranged alternately with respect to the positive pole plates. The positive plate stack 44 comprises a positive output conductor metal sheet 48 and the negative plate stack 46 has a negative output conductor metal sheet 50. The output conductor metal sheets 48, 50 serve for the mechanical fixing and electrical contact-connection of the respective pole plates. The negative output conductor metal sheet 50 can be composed of nickel-plated steel sheet. The positive output conductor metal sheet 48 is composed of nickel.

When the first-cell plate stack 24, as shown in FIG. 1a, is introduced into the first cell vessel 12 in the direction of an arrow P, the spring tongues 38.1 to 38.12 are pre-stressed and present only a low mechanical resistance to the insertion. Withdrawal of the first-cell plate stack 24 is prevented, however, by the fact that the free ends 51.1, 51.2, . . . , 51.12 of the spring tongues 38.1 to 38.12 load the output conductor metal sheets 48 and 50 (FIG. 1c) and said spring tongues thus present a higher resistance to said withdrawal.

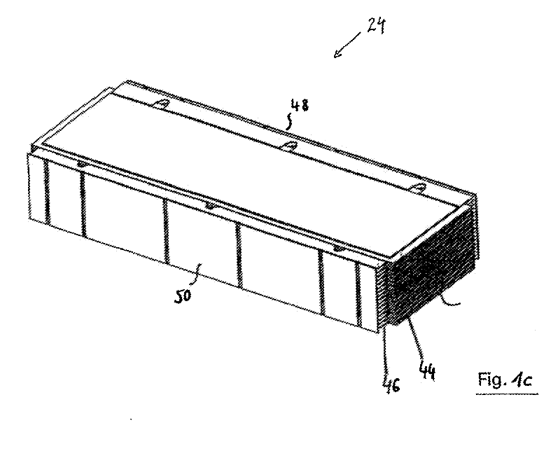

FIG. 2a shows a view of the intermediate wall 30.1 in the viewing direction of an arrow A such as is designated in FIG. 1a. The second first-cell contact connector metal sheet 34 is fixed to the intermediate wall 30.1 by means of rivets 42.1 to 42.6, the spring tongues 38.7 to 38.12 projecting from said metal sheet. Each of the spring tongues 38.7 to 38.12 is multiply slotted, thus giving rise to respective partial spring tongues. This further improves the contact between the spring tongues and the output conducting metal sheets 48, 50 (FIG. 1c). This circumstance is indicated by the two curved arrows P₁ and P₂ in FIG. 2b.

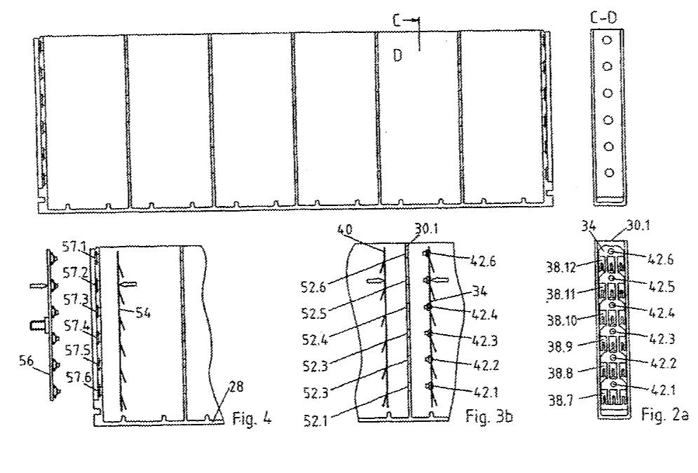

For mounting a contact connector metal sheet, such as the second first-cell contact connector metal sheet 34, for example, on the associated intermediate wall, as is shown in FIG. 3a, firstly the rivets 42.1 to 42.6 are inserted into respective holes. A head of the rivet is subsequently formed by cold forming, whereby the corresponding rivet is fixedly connected to the first-cell contact connector metal sheet 34. As an alternative, the rivets have been formed on the first-cell contact connector metal sheet 34 by reshaping.

FIG. 3b shows how this first-cell contact connector metal sheet provided with the rivets is aligned with rivet holes 52.1, 52.2 . . . , 52.6 in such a way that the rivets lie in front of the respective rivet holes 52.1 . . . , 52.6. From the other side of the intermediate wall 30.1, the first second-cell contact connector metal sheet 40 is positioned relative to the intermediate wall 30.1 in such a way that the rivets 42.1, . . . , 42.6 can reach through the second-cell contact connector metal sheet 40. The two contact connector metal sheets 34, 40 are subsequently riveted to one another by the rivets 42.1, . . . , 42.6 being subjected to cold forming. The rivet holes 52.1 to 52.6 have a diameter that is dimensioned such that the rivet holes form a press fit with the associated rivet. The dimension “a” of the rivet, that is to say the shaft length thereof, is moreover smaller than the thickness of the intermediate wall 30 by a small amount. An axial bracing of the contact connector metal sheets is thus achieved. After the riveting of the contact connector metal sheets 34, 40, the first cell vessel (FIG. 1a) is connected tightly with respect to alkaline solution from the second cell vessel 14.

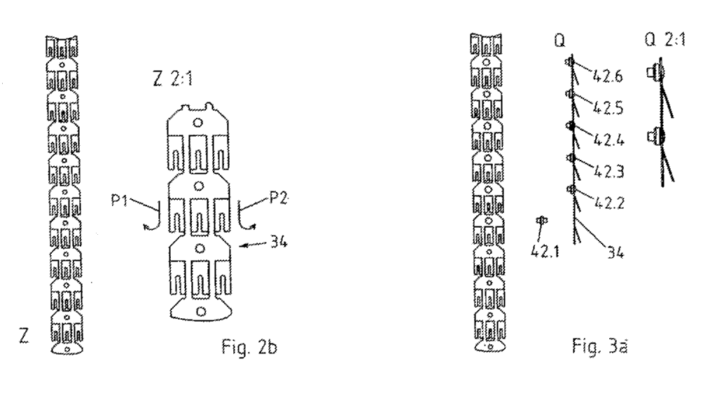

FIG. 4 shows a riveting of a marginal contact connector metal sheet 54 to a pole connector element 56. The pole connector element 56, as described above for the contact connector metal sheet 34, is connected to rivets or butt-welded by means of electric stud welding and is subsequently aligned with openings 57.1, 57.2 . . . , 57.6 in the basic body 28 in such a way that the rivets can reach through the openings. The marginal contact connector metal sheet 54 is subsequently riveted to the pole connector element 56 in such a way that a connection which is substantially gas-tight and tight with respect to alkaline solution is produced between the two. Insofar as is necessary for achieving gas-tightness, it is possible to arrange sealing elements, for example O-rings, around the rivets.

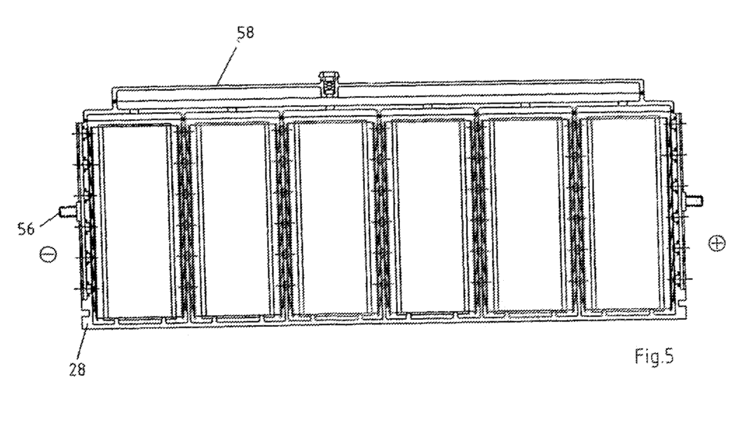

In order to produce the prismatic accumulator 10 (FIG. 1a) firstly the basic body 28 is produced and the contact connector metal sheets are prefabricated. Afterward, the contact connector metal sheets are fitted to the intermediate walls 30.1, . . . , 30.5 either simultaneously or successively during mass production on an automatic assembly line. In addition, the pole connector elements, such as the pole connector element 56, are joined to the basic body 28, the contact connector metal sheet 32, 54 being riveted on. The plate stacks such as the first-cell and the second-cell plate stack 24 and 26, respectively, are subsequently inserted into the respective cell vessels 12 and 14. Finally, the accumulator 10, as is shown in FIG. 5, is provided with a cover 58 fixed to the basic body 38 in gas-tight fashion.

What is claimed is:

1. A prismatic accumulator comprising:
a first cell vessel having a first-cell plate stack disposed therein;
at least one second cell vessel having a second-cell plate stack disposed therein and separated from the first cell vessel by an electrically insulating intermediate wall;
at least one first-cell contact connector metal sheet provided in the first cell vessel that is connected to the intermediate wall and is in contact with the first-cell plate stack;
at least one second-cell contact connector metal sheet provided in the second cell vessel that is in contact with the second-cell plate stack;
wherein each of the contact connector metal sheets is in contact with the associated plate stack via at least one spring tongue, wherein the at least one spring tongue exerts a mechanical pressure on the associated plate stack with a free end that is in contact with the respective plate stack and is arranged such that it presents a higher mechanical resistance to a movement of the plate stack out of the associated cell vessel than to a movement into the associated cell vessel.

2. The prismatic accumulator of claim 1, wherein the second-cell contact connector metal sheet is connected to the intermediate wall in a manner lying opposite the first-cell contact connector metal sheet with respect to the intermediate wall.

3. The prismatic accumulator of claim 1, wherein the plate stacks each have at least one output conductor metal sheet and the spring tongues exert the mechanical pressure on the at least one output conductor metal sheet.

4. The prismatic accumulator of claim 1, wherein each plate stack is in contact with at least three spring tongues on both sides.

5. The prismatic accumulator of claim 1, wherein the first-cell contact connector metal sheet and the second-cell contact connector metal sheet are mechanically and electrically connected by at least one rivet.

6. The prismatic accumulator of claim 5, wherein the at least one rivet runs through a rivet hole in the intermediate wall and forms a press fit with the rivet hole.

7. The prismatic accumulator of claim 6, characterized in that the press fit is formed such that the rivet is arranged in the rivet hole tightly with respect to alkaline solution.

8. The prismatic accumulator of claim 5, wherein the at least one rivet braces the associated contact connector metal sheet axially against the associated intermediate wall.

9. The prismatic accumulator of claim 1, further comprising exactly two contact connector metal sheets per cell vessel that are arranged on both sides of the associated plate stack.

10. The prismatic accumulator of claim 1, wherein the spring tongues are formed integrally on the respective contact connector metal sheet.

11. The prismatic accumulator of claim 1, wherein the prismatic accumulator is a nickel-metal hydride accumulator or a nickel-cadmium accumulator.

12. The prismatic accumulator of claim 1, wherein:
a positive first-cell plate stack and a negative first-cell plate stack are disposed in the first cell vessel; and
a positive second-cell plate stack and a negative second-cell plate stack are disposed in the second cell vessel;
wherein the at least one first-cell contact connector metal sheet and the at least one associated second-cell contact connector metal sheet are arranged in such a way that the positive first-cell plate stack of the first cell vessel is connected to the negative second-cell plate stack of the second cell vessel or the negative first-cell plate stack of the first cell vessel is connected to the positive second-cell plate stack of the second cell vessel.

13. The prismatic accumulator as claimed in claim 1, wherein the contact connector metal sheets are composed of nickel-plated spring steel.

14. A method for producing a prismatic accumulator comprising:
providing a housing having a first cell vessel and at least one second cell vessel which are separated from the first cell vessel by an electrically insulating intermediate wall;
introducing at least one first-cell contact connector metal sheet into the first cell vessel;
introducing at least one second-cell contact connector metal sheet into the second cell vessel;
connecting the at least one first-cell contact connector metal sheet to the at least one second-cell contact connector metal sheet; and
introducing at least one first-cell plate set into the first cell vessel such that it is brought into permanent contact with the at least one first-cell contact connector metal sheet;
introducing at least one second-cell plate stack into the second cell vessel such that it is brought into contact with the at least one second-cell contact connector metal sheet;
wherein each of the contact connector metal sheets has at least one spring tongue and is introduced in such a way that the at least one spring tongue exerts a mechanical pressure on the associated plate stack with a free end that is in contact with the plate stack, and is arranged in such a way that it presents a higher mechanical resistance to a movement of the plate stack out of the cell vessel than to a movement into the cell vessel.

15. The method of claim 14, wherein the step of connecting the at least one first-cell contact connector metal sheet to the at least one second-cell contact connector metal sheet comprises riveting.

16. The method of claim 15, wherein the riveting is cold riveting.

17. The method of claim 15, wherein the riveting uses a rivet having dimensions that are so large relative to an associated rivet hole to provide a seal-free riveted connection that is tight with respect to alkaline solution.

18. The method of claim 14, wherein the contact connector metal sheets are prefabricated.
